(19) United States
(12) Patent Application Publication
(10) Pub. No.: US 2018/0174082 A1
(43) Pub. Date: Jun. 21, 2018

(54) PERCEIVED QUALITY OF SERVICE

(71) Applicant: Palo Alto Research Center Incorporated, Palo Alto, CA (US)

(72) Inventors: Lara S. Crawford, Belmont, CA (US); Daniel H. Greene, Sunnyvale, CA (US); Marzieh Nabi-Abdolyousefi, San Jose, CA (US)

(73) Assignee: Palo Alto Research Center Incorporated, Palo Alto, CA (US)

(21) Appl. No.: 15/382,365

(22) Filed: Dec. 16, 2016

(51) Int. Cl. G06Q 10/06

(52) U.S. Cl. CPC G06Q 10/0631

(57) ABSTRACT

Embodiments of the present invention provide a system for modeling Quality of Service (QoS) including a customer's perceived QoS, and optimizing QoS and perceived QoS. The system improves significantly over previous systems and can conserve resources by optimizing the level of resource allocations to satisfy a Service Level Agreement (SLA), while satisfying the customer's impression of QoS. During operation, the system obtains an SLA between a provider and a customer, specifying a QoS metric and a corresponding range. The system then optimizes the customer's perceived QoS, which further comprises modeling the customer's perceived QoS and the QoS metric, based on an operational allocation of the provider. Optimizing the perceived QoS may further comprise determining an optimized level of the allocations that enhances the customer's modeled perceived QoS, and also corresponds to a modeled QoS metric within the range. The system may then set the provider's allocation to the optimized level.

### BACKGROUND

### Field

The present disclosure relates to Quality of Service (QoS). More specifically, this disclosure relates to a method and system for optimizing QoS based on a model of perceived QoS and of a QoS metric.

### Related Art

A service provider may typically provide operational resource allocations, or inputs (such as provided computer processing, data, information and communication services, transportation, hospitality or other services, catered food, etc.) in order to deliver services to a customer, whether a consumer, a business, or another intermediary organization. In providing such allocations, the provider may face constraints on resources or costs of resources that fluctuate in time. For example, input costs could include electricity costs that fluctuate during the course of a day, gasoline or other fuels, human labor, raw ingredients or materials, research and development costs, or property and equipment depreciation. In response to such fluctuating costs or supply, as well as to fluctuating demands from customers, a provider may wish to optimize the amount and timing of allocations the provider provides. Typically the provider may do so by varying quantity or quality of allocations in response to fluctuating costs, while still satisfying an agreed-upon Service Level Agreement (SLA) with the customer specifying an acceptable range of values for various quality of service (QoS) metrics.

However, simply providing sufficient allocations to satisfy the SLA may leave customers with a poor impression. In particular, an SLA may often stipulate a minimum or range of acceptable values of a QoS metric, but simply satisfying the minimum acceptable level of QoS may do little to convince a customer of good provided value. Optimizing QoS by minimizing costs and merely satisfying the SLA runs a danger of setting too low a QoS target, whereas exceeding the SLA could produce inefficient allocation of resources.

In many cases, customers' impressions of QoS are formed instinctively rather than logically or based on objective metrics such as those in an SLA. Behavioral economics research shows that perception of the quality of an experience is not always rational, and in fact is often based on heuristics. As described in some of Kahneman's groundbreaking work (see, for example, Thinking Fast and Slow by Daniel Kahneman, published by Farrar, Straus and Giroux, 2011, hereby incorporated by reference in the present application), people can be described as having two modes of mental operation, System 1 and System 2. System 1 is intuitive and very quick to operate and judge a situation, but tends to be heuristic-based, and therefore not strictly rational. System 2 is more rational, and is called into play when a situation demands more in-depth analysis, when System 1 is unsure, or when a person focuses on the details of a problem. In evaluating QoS, an individual's System 1 would give an impression of how the service was performing, whereas System 2 would analyze the service's performance, e.g. with respect to metrics such as in an SLA. To truly satisfy the customer's expectations, the service must satisfy both System 1 and System 2, as the customer may operate in either mode at any given time.

Behavioral economics has also shown that many irrationalities in decision making are systematic and can be anticipated. For example, the framing effect refers to people's tendency to treat the same situation or choices differently depending on whether something is perceived as a loss or a gain. This finding matches research in customer expectations, which shows that both the raw performance of a product and the difference between performance and expected performance play a role in customer perceptions. Likewise, prospect theory implies that dips below expectations have more negative effects on perceived QoS than peaks above expectations have positive, and there seems to be an absolute minimum performance threshold expected for acceptable service. Customer expectations can also change over time, e.g. by adapting to experienced levels of service. For example, the worst and most recent performance experienced are often the most salient (the so-called peak-end rule).

### SUMMARY

One embodiment of the present invention provides a system and method for optimizing Quality of Service (QoS) based on a model of perceived QoS and of a QoS metric. During operation, the system obtains a Service Level Agreement (SLA) between a provider and a customer, wherein the SLA specifies a QoS metric and a corresponding range. The system then optimizes the QoS metric and a perceived QoS of the customer. This further comprises modeling the customer's perceived QoS based on an operational allocation of the provider and modeling the QoS metric, based on the operational allocation of the provider. Optimizing the perceived QoS may further comprise determining an optimized level of the provider's operational allocation or input that enhances the customer's modeled perceived QoS and the modeled QoS metric. The system may then set the provider's operational allocation to the optimized level.

In a variation on this embodiment, determining the optimized level of the provider's operational allocation may involve constraining the provider's operational allocation to correspond to a modeled QoS metric within the range specified by the SLA.

In a variation on this embodiment, determining the optimized level of the provider's operational allocation involves optimizing the modeled QoS metric via a stochastic constraint or a contribution to an objective function.

In a variation on this embodiment, modeling the customer's perceived QoS may involve basing the perceived QoS on a worst value of the QoS metric over a recent time interval.

In a variation on this embodiment, modeling the customer's perceived QoS involves basing the perceived QoS on one or more of: an average value of the QoS metric over a recent time interval; and a comparison of a recent value of the QoS metric to the average value.

In a variation on this embodiment, modeling the customer's perceived QoS involves basing the perceived QoS on one or more of: a comparison between a recent value of the QoS metric and the range; and the comparison, weighted such that the recent value of the QoS metric falling below the range is weighted more strongly than the recent value falling above the range.

In a variation on this embodiment, determining the optimized level of the provider's operational allocation further comprises one or more of: determining that providing the optimized level of operational allocation will increase a cost associated with the operational allocation by less than a predetermined threshold or proportion; and determining the cost and the enhanced perceived QoS as a function of the optimized level of the operational allocation.

In a variation on this embodiment, determining the optimized level of the provider's operational allocation involves optimizing perceived QoS via one or more of: a constraint; a stochastic constraint; and a contribution to an objective function.

In a variation on this embodiment, the range for the QoS metric includes one or more of: a minimum value of the provider's operational allocation; a deadline for a task completion; and a number of incomplete tasks.

### BRIEF DESCRIPTION OF THE FIGURES

FIG. 1A illustrates an exemplary cost structure of provider allocations.

FIG. 1B illustrates an exemplary optimized provider operational allocation level for the cost structure of FIG. 1A, according to embodiments of the present invention.

FIG. 2 presents a block diagram illustrating an exemplary overall process flow for optimizing perceived Quality of Service (QoS), according to embodiments of the present invention.

FIG. 3 presents a block diagram illustrating an exemplary Quality of Service (QoS) optimization system utilizing the perceived QoS modeling method, according to embodiments of the present invention.

FIG. 4 presents a block diagram illustrating a method for optimizing perceived Quality of Service (QoS) according to embodiments of the present invention.

FIG. 5 illustrates an exemplary tradeoff curve for total cost including perceived Quality of Service (QoS) vs. provider allocation level, according to embodiments of the present invention.

FIG. 6 presents a block diagram illustrating an exemplary apparatus for optimizing Quality of Service (QoS), in accordance with embodiments of the present invention.

FIG. 7 presents a block diagram illustrating an exemplary computer system for optimizing Quality of Service (QoS), in accordance with embodiments of the present invention.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

Embodiments of the present invention solve the problem of optimizing Quality of Service (QoS) by modeling perceived QoS. The system may model a customer's perception of QoS as a function of a provider's operational allocations or inputs, together with outputs such as an agreed-upon QoS metric. The system can improve on previous systems by optimizing QoS, taking into account this modeled perceived QoS. Specifically, the system may optimize perceived QoS, subject to simultaneously satisfying an agreed-upon Service Level Agreement (SLA), which may specify an acceptable range of QoS metric values. In some embodiments, the system may optimize both perceived QoS and a modeled QoS metric. During operation, the system obtains an SLA between a provider and a customer, specifying a QoS metric and a corresponding range. The system then optimizes a perceived QoS of the customer, based on the range, which further comprises modeling the customer's perceived QoS and the QoS metric, based on an operational allocation of the provider. Optimizing the perceived QoS based on the range may further comprise determining an optimized level of the provider's operational allocations that enhances the customer's modeled perceived QoS, and also corresponds to a modeled QoS metric within the range. The system may then set the provider's operational allocations to the optimized level.

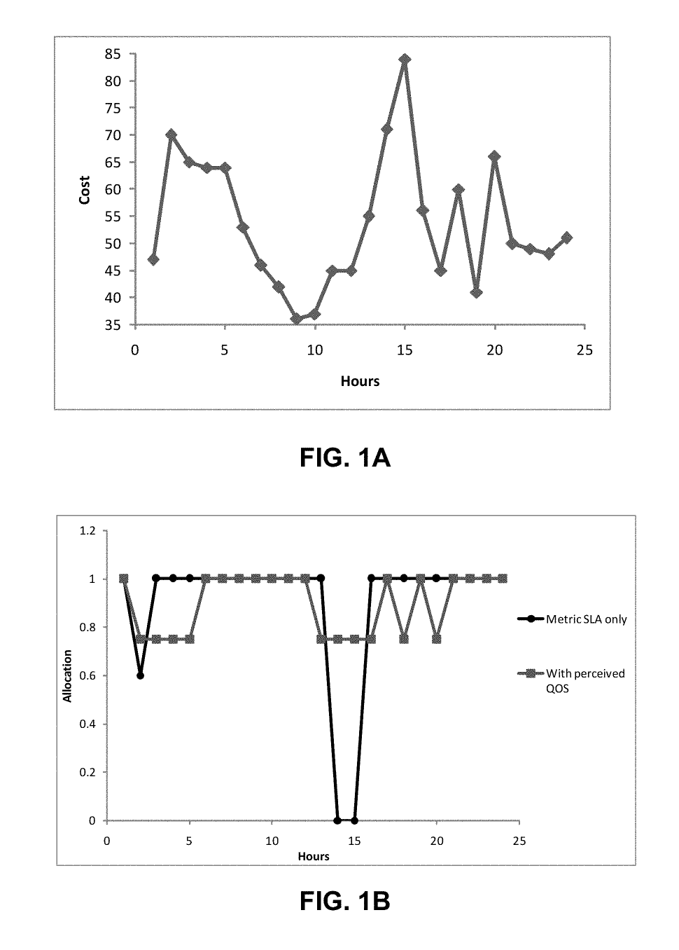

FIG. 1A illustrates an exemplary cost structure of provider operational allocations, or inputs. A provider may typically provide operational allocations or provision resources or capacity in order to deliver services to a customer, whether a consumer, a business, or another intermediary organization. For example, a provider might provide computer processing, database or data center services, information and communication services, job shop services, print shop services, transportation, hospitality or other services, packaging services, a management system for dispatching telephone calls, catered food, etc. In providing such allocations, the provider may face costs of resources that fluctuate in time. For example, the cost structure shown in FIG. 1A may correspond to electricity costs fluctuating during the course of a day. Other example input costs could include costs associated with gasoline or other fuels, human labor, raw ingredients or materials, research and development, or property depreciation. In response to such fluctuating costs or supply, as well as to fluctuating demands from customers, a provider may wish to optimize the amount and timing of operational allocations the provider provides. Typically the provider may do so by varying quantity or quality of inputs in response to fluctuating costs, while still satisfying an agreed-upon SLA specifying an acceptable range of values for various QoS metrics.

However, simply providing sufficient allocations to satisfy the SLA may leave customers with a poor impression. In particular, an SLA may often stipulate a minimum or range of acceptable values of a QoS metric, but simply satisfying the minimum acceptable level of QoS may do little to convince a customer of good provided value. Optimizing QoS by minimizing costs and merely satisfying the SLA runs a danger of setting too low a QoS target, whereas exceeding the SLA could produce inefficient allocation of resources. The disclosed system can improve on previous systems that optimize QoS, by taking into account a model of perceived QoS. This can help conserve resources by optimizing the level of provided operational allocations in a way that satisfies the SLA, and leaves the customer satisfied with QoS.

FIG. 1B illustrates an exemplary optimized provider operational allocation level for the cost structure of FIG. 1A, according to embodiments of the present invention. As shown, the optimized provider allocation level may depend strongly on whether the optimization is performed including a model of perceived QoS. For example, a simple SLA might specify a minimum number of hours of operation of a data center. Given the power cost structure shown in FIG. 1A, the data center could satisfy the letter of the SLA by operating at full capacity (shown normalized to 1) during the cheapest available time slots of the day, until fulfilling its minimum number of operation hours. To cut costs or conserve resources, the data center could shut down completely for the remaining hours when electricity is more expensive, even if the cost differences are only slight. Such an optimized solution is shown with the label “Metric SLA only,” and gives the lowest possible cost while satisfying the QoS metric guidelines in the SLA.

On the other hand, an optimized solution taking into account a simple model of perceived QoS is shown in FIG. 1B with the label “With perceived QoS.” Research shows that the worst performance experienced may influence a customer's perceptions disproportionately. Since the “Metric SLA only” solution includes time intervals with zero operational allocation, including this worst-performance effect in the model could strongly affect perceived QoS and the optimized solution.

To model this effect, the system can subtract the minimum operational allocation, as an offset (or penalty term) to the cost function. The resulting optimized solution still lowers operational allocation during the more expensive hours, but not to zero. In optimizing, the system can search through the space of possible values of xₘ the lowest allocation, to find a value that best balances cost with perceived QoS. As shown, the system then directs the data center to operate at full capacity during the cheapest hours, and at xₘ during more expensive hours, until fulfilling the SLA minimum for operation hours. Such a solution optimizes the model of perceived QoS, together with costs, and subject to the constraint of satisfying the SLA.

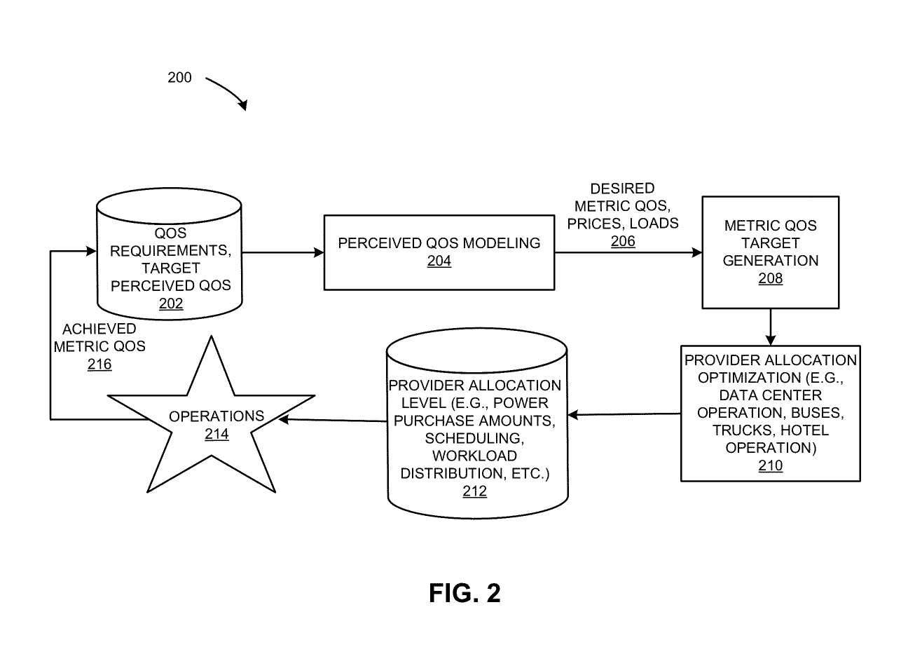

As this example illustrates, the desired perceived QoS is determined based on a tradeoff between the system's predicted ability to achieve a particular level of service, costs associated with that service, and benefits in terms of customer satisfaction. FIG. 2 presents a block diagram illustrating an exemplary overall process flow 200 for optimizing perceived Quality of Service (QoS), according to embodiments of the present invention. As process flow 200 shows, this tradeoff is a general consideration for perceived QoS modeling.

During operation, the system obtains QoS requirements or target perceived QoS 202. The system may then model perceived QoS (operation 204). Based on modeling 204, and taking into account desired metric QoS, prices, and loads 206, the system may generate a target QoS 208. The system may then optimize provider resource allocations (operation 210) to obtain optimized provider allocation level 212. For example, the provider may provide data center operation, transportation such as buses or trucks, or hotel operation, and the system could optimize the level of electrical or other power purchased, scheduling of transportation services, workload distribution, etc. Based on optimized provider allocation level 212, the system may then set the provider's operational allocations to the optimized level during the provider's operations 214. Thus, the disclosed system can improve operations 214 compared to previous systems by optimizing the level of provided operational allocations subject to the SLA, conserving resources, and leaving the customer more satisfied with QoS than previous systems. Based on operations 214, the system may achieve the guideline for metric QoS 216 stipulated by the SLA and/or desired metric QoS 206, thereby feeding back into overall process flow 200 for future optimization.

### System Architecture

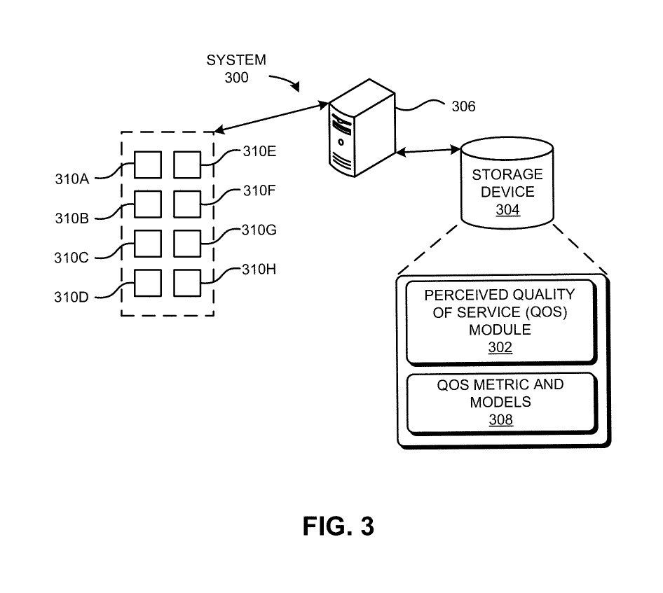

FIG. 3 presents a block diagram illustrating an exemplary Quality of Service (QoS) optimization system utilizing the perceived QoS modeling method, according to embodiments of the present invention. A QoS optimization system 300 may divide a model and optimize QoS, according to embodiments, in parallel with multiple processors. In standard systems, system 300 may set too low a QoS target by merely satisfying the SLA, whereas exceeding the SLA could produce inefficient allocation of resources. Using the methods disclosed herein, system 300 optimizes the level of provided operational allocations subject to the SLA, thereby conserving resources, and leaving the customer more satisfied with QoS than previous systems.

QoS optimization system 300 may include a perceived QoS module 302 installed on a storage device 304 coupled to a server 306. Note that various implementations of the present invention may include any number of computers, servers, and storage devices. In various implementations, perceived QoS module 302 may include a QoS optimizing module or other components of QoS optimization system 300 to perform the techniques described herein. System 300 may receive data describing a QoS metric and/or models, and store such data in storage device 304. System 300 may read the code for perceived QoS module 302 and the data for degradation measurements and features 308 from storage device 304. System 300 may divide a metric and/or models, and assign them to processors, such as processors 310A-310H, which operate on the assigned metric and/or models.

### Method for Optimizing Quality of Service

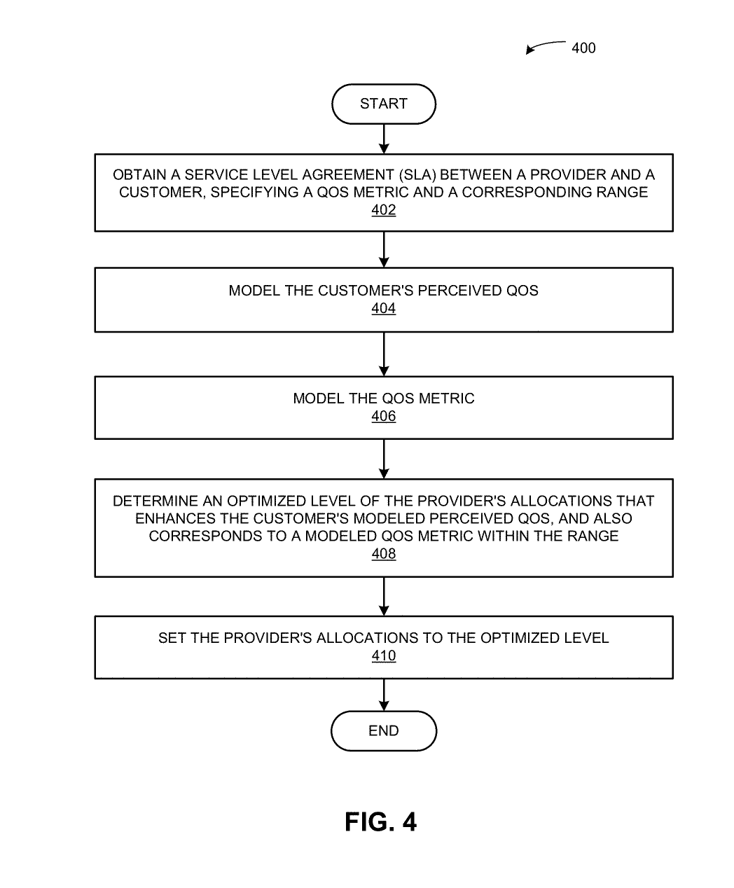

FIG. 4 presents a block diagram illustrating a method 400 for optimizing perceived Quality of Service (QoS) according to embodiments of the present invention. During operation, the system obtains a Service Level Agreement (SLA) between a provider and a customer, wherein the SLA specifies a QoS metric and a corresponding range (operation 402). In some embodiments, the metric (which may also be referred to as a hard QoS measure, technical QoS, actual QoS, or even simply as the QoS or the SLA) may be a measurable, objective indicator that tracks the level of provided service, such as: an operational input or allocation of the provider (e.g., a number of daily hours and allocated capacity of data center operation, a number of passenger-miles of provided transportation, or a quantity of meals served); criteria for completion of a task (e.g., serving a computational query or result within a given time or budget, a predetermined milestone toward a larger goal); or a number of incomplete tasks. The corresponding range may be a guideline range for acceptable values of the QoS metric, such as a minimum value of the provider's operational allocations, a deadline for satisfaction of the task completion criterion, or a maximum number of incomplete tasks. The SLA may stipulate that the provider must deliver services in order to keep the QoS metric within this specified range. In some embodiments, the SLA may instead stipulate target values, or minimum total values per unit time, for the provider operational allocations. Examples of SLA requirements or ranges are given in Table 1, together with a comparison to possible customer expectations, which can potentially differ from a strict interpretation of the SLA. These customer expectations could in turn affect customer perceptions of QoS.

TABLE 1
Examples of SLA requirements and comparison to
possible customer expectations or perceptions.

| Example SLA requirement | Possible customer expectations |
|---|---|
| Minimum values for resource | Performance will always be above |
| provisioning | these minima |
| Target values for resource | Performance may occasionally dip |
| provisioning | below specified targets, possibly |
| | incurring a penalty |
| Minimum total values of | Even if resource provisioning is met |
| resource provisioned per unit | partway through the time period, |
| time | service will continue |

The system may then optimize a perceived QoS of the customer, based on the range for the QoS metric. This may further comprise modeling the customer's perceived QoS based on an operational input by the provider (operation 404) and modeling the QoS metric based on the operational allocations by the provider (operation 406). Specifically, in some embodiments, the system may model perceived QoS and the QoS metric as functions of the provider's operational allocations. In various embodiments, these modeling functions may be numerical or analytic, and may be designed by experts, based on known research findings, or may be learned automatically by the system, using various techniques such as machine learning that are known in the art. In some embodiments, the system may optimize multiple metrics and/or provider operational allocations, and the modeling functions may be simultaneous functions of multiple provider allocations and/or other variables or parameters.

Note that although the perceived QoS is generally more subjective than the QoS metric, the perceived QoS may nevertheless also be measurable and well-defined. For example, perceived QoS may be quantified by a survey using scientific scales such as a Likert or rating scale, or measured by other methods such as focus groups. Then the goal of the perceived QoS model in operation 404 may be to predict the outcomes of such perceived QoS measurements.

In some embodiments, the system may model perceived QoS in operation 404 based on various statistics, relationships, or heuristics involving the QoS metric and/or other variables. For example, the system may model perceived QoS based on an average of previous performance (i.e., the QoS metric), possibly including a model of forgetting (e.g., an average over a recent time interval, or weighted by a decaying factor over time). The system may model perceived QoS based on differences between delivered metric QoS and the SLA-specified range, possibly with dips below the target weighted more strongly than peaks above. The system may model perceived QoS based on the most recent performance as compared to the average. In some embodiments, the system may model perceived QoS based on the worst performance ever experienced (possibly with a decay factor or forgetting model as well). In some embodiments, the system may model perceived QoS based on an absolute minimum performance threshold.

Optimizing the perceived QoS based on the range may further comprise determining an optimized level of the provider's operational allocations that enhances the customer's modeled perceived QoS, and also corresponds to a modeled QoS metric within the range (operation 408). In some embodiments, the system may carry out optimization 408 within the models resulting from operations 404 and 406. In some embodiments, because satisfying the QoS or ‘hard’ metric is mandatory within the SLA, the system may give the QoS metric higher priority within optimization 408 than the perceived QoS. That is, in some embodiments the system may optimize perceived QoS only within a restricted space of operational allocations, e.g. those that satisfy the SLA, or subject to the constraint of satisfying the SLA. In some embodiments, the system may do so by treating perceived QoS as an offset (or penalty term) to a cost function or to provider operational allocations, as in the example of FIG. 1B above. In some embodiments, determining the optimized level of the provider's operational allocations may involve optimizing perceived QoS via a hard or soft constraint, a stochastic constraint, and/or a contribution to an objective function.

In some embodiments, the system may make use of various other strategies to incorporate perceived QoS into the QoS optimization. In some embodiments, the system may optimize metric QoS, rather than restrict operational allocations to those that satisfy the SLA. The system may optimize both perceived QoS and a modeled QoS metric based on a stochastic constraint, offset, or penalty function model. For example, the system may combine perceived QoS with the QoS metric from the SLA with a an offset or penalty function model, by using a weighting factor that depends on proximity to the QoS metric. The system may then optimize using this combined measure. The system may also shift from optimizing for perceived QoS to optimizing for the QoS metric depending on proximity to the QoS metric. In some embodiments, the system may optimize for perceived QoS only when doing so increases costs by less than a predetermined threshold percentage or amount. In some embodiments, the system optimizes using a tradeoff curve for cost relative to QoS. In some embodiments, the system artificially raises the QoS requirements to provide a ‘cushion’ or margin of safety for perceived QoS.

In some embodiments, optimization 408 may take into account time or treat the QoS metric, perceived QoS, and/or provider operational allocations as time series, or may optimize the provider allocations over time, as illustrated by FIGS. 1A and 1B. After optimizing the provider's allocations, the system may then set the provider's operational allocations to the optimized level (operation 410).

A key to successfully optimizing perceived QoS is prediction. For example, to eliminate dips below a desired performance minimum, the system must predict its available resources and system loads well into the future, so it can ensure resources are available even at times of high demand. In addition, the desired minimum QoS will be based on a tradeoff among many factors, including the benefit in terms of enhanced customer satisfaction, the cost of resources required to achieve the desired QoS, the risks inherent in the uncertain future situation (e.g., expending resources but failing to achieve the desired QoS), and so on. Thus, advance planning is essential to mitigate these challenges.

### Exemplary Tradeoff Curve and Applications

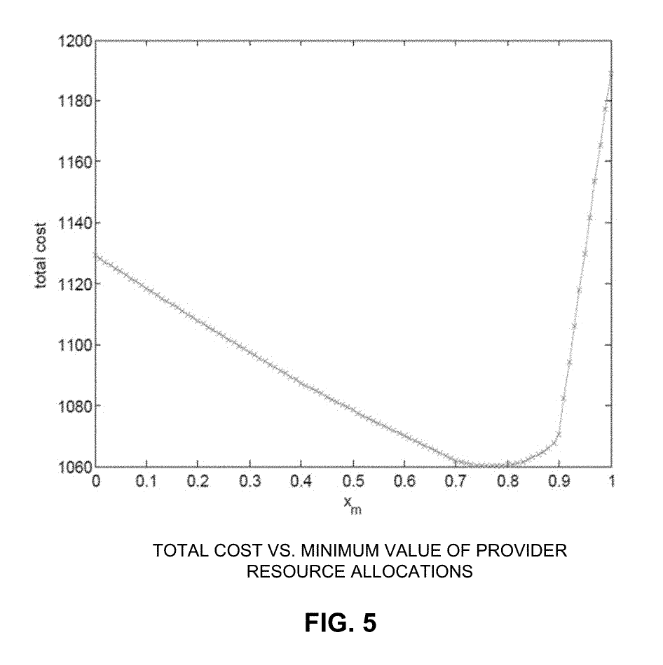

FIG. 5 illustrates an exemplary tradeoff curve for total cost including perceived Quality of Service (QoS) vs. provider allocation level, according to embodiments of the present invention. The tradeoff curve shown corresponds to the example of FIGS. 1A and 1B in the domain of data center operation. As discussed above, in some embodiments, the system may treat perceived QoS as an offset in a cost function or objective function, or may perform soft or stochastic optimization. In this example, the minimum provider allocation xₘ is subtracted as an offset from the cost function.

In order to solve the optimization problem approximately, in some embodiments, the system may generate an optimized solution for the operational allocation time series, minimizing total cost and satisfying the SLA, for each value of xₘ in some range. The system may discretize the xₘ range in order to facilitate this computation. The system may then determine a global optimum by comparing the overall desirability of each such optimized solution (e.g., in this case by comparing the total cost including the offset) as a function of xₘ. Such a comparison is illustrated as the tradeoff curve in FIG. 5. As shown, in this example, a minimum allocation corresponding to xₘ=0.78 is globally optimal. This value is also reflected as the minimum allocation value in the optimized curve including perceived QoS in FIG. 1B.

To study this example in greater depth, assume that the electricity cost to the data center provider is given by p=Σᵢcᵢ(a+bxᵢ). Here cᵢ is the electricity price at hour i as shown in FIG. 1A, xᵢ is the provider's allocation (which we assume to be normalized so that 0 ≤xᵢ≤1) at hour i, and a +bxᵢ is a typical expression for power consumption as a function of CPU load xᵢ in servers. The SLA in this example requires a minimum total QoS metric: Σᵢxᵢ≥q. Minimizing the electricity cost p subject to this requirement then results in the “Metric SLA only” solution shown in FIG. 1B, i.e. xᵢ=1 for all the lowest-cost intervals i (with 0 ≤xᵢ≤1 for the last of these), and xᵢ=0 for the remaining intervals, such that the sum of the xᵢ equals q.

To incorporate the model of perceived QoS, the system may subtract the minimum allocation xₘ=minᵢxᵢ as an offset from the cost function, as described above: p′=p−kxₘ. This modified optimization can be solved by defining yᵢ=xᵢ−xₘ, so that for each given value of xₘ, the problem becomes min_{y}_{ᵢ}Σᵢcᵢyᵢ subject to Σᵢyᵢ≥q−nxₘ, where n is the total number of intervals. This problem, expressed in the modified variables yᵢ for a given value of xₘ, is very similar to the metric-only optimization just considered. This problem can likewise be solved by setting yᵢ=1−xₘ (i.e., xᵢ=1) for the lowest-cost intervals i (with an intermediate value of yᵢ for one interval, if necessary), and yᵢ=0 (i.e., xᵢ=xₘ) for the remaining intervals, such that the sum of the yᵢ equals q−nxₘ. As discussed above, the system may then determine a global optimum by comparing the total cost including the offset term as a function of xₘ.

To consider a more complex example in the domain of data center operation, assume that QoS may be assessed taking into account a job's deadline, whether for an interactive or a batch job. That is, job i is expected to be completed within at most time Wⁱ₁ from being initiated, or else a financial penalty c^{p}₁ will be charged and a second chance will be granted, Wⁱ₂. If the application is not completed within time Wⁱ₂, a second penalty c^{p}₂ is applied and the job dropped. The SLA allows at most a number Dⱼ of such failures for a client j. Even assuming the number of failures remains fewer than Dⱼ, in order to satisfy the customer's subjective perceptions, it may be preferable to keep the number of failures as low as practically possible. Thus, in some embodiments, the system may seek to optimize perceived QoS, taking into account failures and/or timely job completion.

In an exemplary embodiment, the system may approach this optimization based on an offset (or penalty term) to a total cost function:

$$min {\sum }_{i = 1}^{N} {C}_{i} ( t ) + {c}_{1}^{p} \sum {1}_{\{ {W}_{1}^{i} \leq {\overline{W}}^{i} \leq {W}_{2}^{i} \}} + {c}_{2}^{p} \sum {1}_{\{ {\overline{W}}^{i} \geq {W}_{2}^{i} \}} + \frac{{c}_{internal}^{p}}{{D}_{j} - \sum {1}_{\{ {\overline{W}}^{i} \geq {W}_{2}^{i} \}}} .$$

Here W̅ⁱ is the time required to finish job i and Cᵢ(t) represents non-QoS data center optimization costs (e.g., power use, costs for sending jobs to the cloud, battery use). The 1_{{m}} notation refers to a value of 1 if condition M holds true, and 0 otherwise. Thus, for example,

$$\sum {1}_{\{ {\overline{W}}^{i} \geq {W}_{2}^{i} \}}$$

is a count of dropped jobs. The counts

$$\sum {1}_{\{ {\overline{W}}^{i} \geq {W}_{2}^{i} \}} and \sum {1}_{\{ {W}_{1}^{i} \leq {\overline{W}}^{i} \leq {W}_{2}^{i} \}}$$

can be efficiently evaluated using techniques known in the queuing theory literature. The last term proportional to C^{p}ᵢₙₜₑᵣₙₐₗ is the offset (or penalty term) representing a model of perceived QoS. Note that this perceived QoS term is in addition to the explicit financial charges c^{p}₁ and c^{p}₂ for late or dropped jobs, and that it increases very fast as the number of dropped jobs approaches the SLA limit Dⱼ.

In some embodiments, the system may react to failure in a more real-time manner. Each time a failure occurs, the QoS may impose more severe constraints on the optimization algorithm. As time passes, a forgetting factor may reduce the impact of these failures on the QoS. One way to model this is that if t_{f} is the time of failure,

$$( e . g . , {1}_{\{ {\overline{W}}^{i} \geq {W}_{2}^{i} \}} = 1 for job i at time {t}_{f} ) ,$$

the weight on the cost function in can be modified by a factor such as

$$\frac{1}{{t}_{ } - {t}_{f}} or {e}^{- ( t - {t}_{f} )} ,$$

e.g., cᵢₙₜₑᵣₙₐₗ^{p}→cᵢₙₜₑᵣₙₐₗ^{p}e−(t−t_{f}).

Because the count terms are non-convex, in some embodiments, the system may use a simpler or more amenable expression. In some embodiments, the model may be replaced by: min Eᵢ₌₁^{N}(Cᵢ(t)+qᵢ(μ)c₁^{p}+q2(μ)c2p. Here μ is the rate at which service requests are removed from the queue; q₁(μ) is the probability of a job failing in the first step (W₁ⁱ≤W̅ⁱ≤W₂ⁱ) and q₂(μ) is the probability of failing in the second try (W̅ⁱ≥W₂ⁱ).

### Exemplary Apparatus

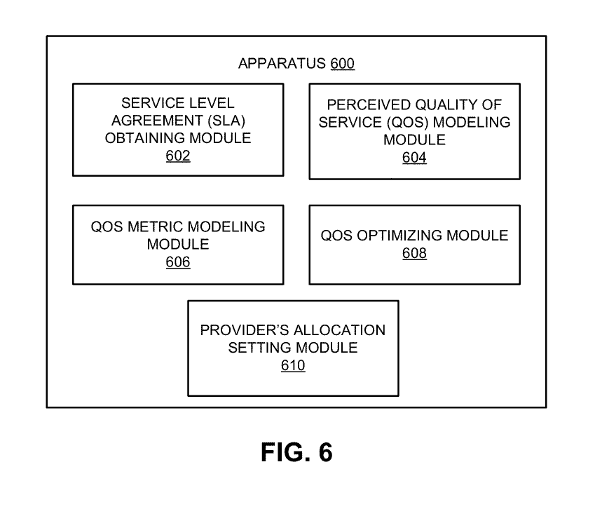

FIG. 6 presents a block diagram illustrating an exemplary apparatus for optimizing Quality of Service (QoS), in accordance with embodiments of the present invention. Apparatus 600 can comprise a plurality of modules which may communicate with one another via a wired or wireless communication channel. Apparatus 600 may be realized using one or more integrated circuits, and may include fewer or more modules than those shown in FIG. 6. Further, apparatus 600 may be integrated in a computer system, or realized as a separate device which is capable of communicating with other computer systems and/or devices. Specifically, apparatus 600 can comprise a Service Level Agreement (SLA) obtaining module 602, a perceived QoS modeling module 604, a QoS metric modeling module 606, a QoS optimizing module 608, and a provider's operational allocation setting module 610. Note that apparatus 600 may also include additional modules not depicted in FIG. 6.

In some embodiments, SLA obtaining module 602 can obtain an SLA between a provider and a customer, specifying a QoS metric and a corresponding range. Perceived QoS modeling module 604 may model the customer's perceived QoS, based on an operational allocation or input by the provider. QoS metric modeling module 606 may model the QoS metric, based on the allocation by the provider. QoS optimizing module 608 may determine an optimized level of the provider's operational allocations that enhances the customer's modeled perceived QoS, wherein the optimized level also corresponds to a modeled QoS metric within the range. Provider's allocation setting module 610 may set the provider's operational allocations to the optimized level. Note that perceived QoS module 302 illustrated in FIG. 3 may provide any and all functions of the various modules depicted in FIG. 6.

### Exemplary System

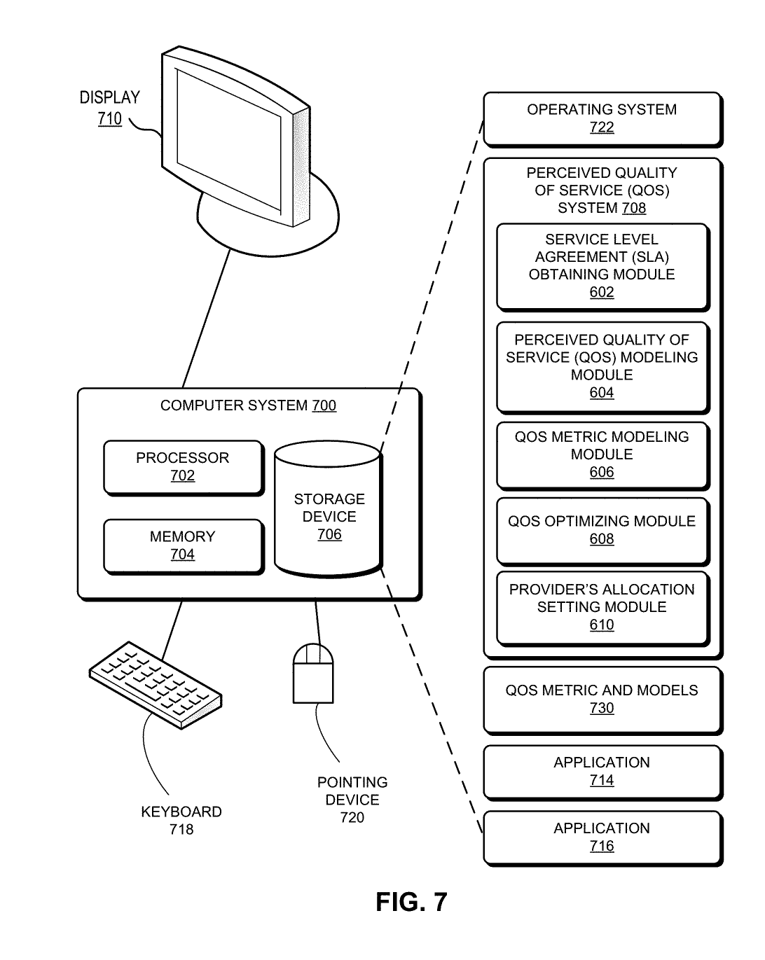

FIG. 7 presents a block diagram illustrating an exemplary computer system for optimizing Quality of Service (QoS), in accordance with embodiments of the present invention. In some embodiments, computer system 700 may be a server. In some embodiments, system 700 includes a processor 702, a memory 704, and a storage device 706. In some embodiments, 702 may include a set of processors. Storage device 706 may store a number of applications, such as applications 714 and 716, which may make use of QoS modeling and optimization according to embodiments of the present invention, and operating system 722. Storage device 706 also stores perceived QoS system 708 that may include a Service Level Agreement (SLA) obtaining module 602, a perceived QoS modeling module 604, a QoS metric modeling module 606, a QoS optimizing module 608, and a provider's allocation setting module 610. System 700 and/or SLA obtaining module 602 may receive or generate QoS metric and models 730 comprising QoS data and may copy QoS data to a memory section accessible to perceived QoS system 708. During operation, one or more applications, such as perceived QoS system 708, are loaded from storage device 706 into memory 704 and then executed by processor set 702. While executing the program, processor set 702 performs the aforementioned functions. System 700 may be coupled to a display 710, a keyboard 718, and a pointing device 720.

In some embodiments, SLA obtaining module 602 can obtain an SLA between a provider and a customer, specifying a QoS metric and a corresponding range. Perceived QoS modeling module 604 may model the customer's perceived QoS, based on an allocation by the provider. QoS metric modeling module 606 may model the QoS metric, based on the operational allocations by the provider. QoS optimizing module 608 may determine an optimized level of the provider's operational allocations that enhances the customer's modeled perceived QoS, wherein the optimized level also corresponds to a modeled QoS metric within the range. Provider's allocation setting module 610 may set the provider's operational allocations to the optimized level. Note that perceived QoS module 302 illustrated in FIG. 3 may provide any and all functions of the various modules depicted in FIG. 7.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-executed method for optimizing perceived Quality of Service (QoS), comprising:
obtaining, by a computer, a Service Level Agreement (SLA) between a provider and a customer, wherein the SLA specifies a QoS metric;
optimizing the QoS metric and a perceived QoS for the customer, which further comprises:
modeling the customer's perceived QoS, based on an operational allocation of the provider;
modeling the QoS metric, based on the operational allocation of the provider; and
determining an optimized level of the provider's operational allocation that optimizes both the customer's modeled perceived QoS and the modeled QoS metric ; and
setting the provider's operational allocation to the optimized level.

2. The method of claim 1, wherein determining the optimized level of the provider's operational allocation involves constraining the provider's operational allocation to correspond to a modeled QoS metric within a range specified by the SLA.

3. The method of claim 2, wherein the range for the QoS metric includes one or more of:
a minimum value of the provider's operational allocation;
a deadline for a task completion; and
a number of incomplete tasks.

4. The method of claim 1, wherein determining the optimized level of the provider's operational allocation involves optimizing the modeled QoS metric via a stochastic constraint or a contribution to an objective function.

5. The method of claim 1, wherein modeling the customer's perceived QoS involves basing the perceived QoS on a worst value of the QoS metric over a recent time interval.

6. The method of claim 1, wherein modeling the customer's perceived QoS involves basing the perceived QoS on one or more of:
an average value of the QoS metric over a recent time interval; and
a comparison of a recent value of the QoS metric to the average value.

7. The method of claim 1, wherein modeling the customer's perceived QoS involves basing the perceived QoS on one or more of:
a comparison between a recent value of the QoS metric and a range specified by the SLA; and
the comparison, weighted such that the recent value of the QoS metric falling below the range is weighted more strongly than the recent value falling above the range.

8. The method of claim 1, wherein determining the optimized level of the provider's operational allocation further comprises one or more of:
determining that providing the optimized level of operational allocation will increase a cost associated with the operational allocation by less than a predetermined threshold or proportion; and
determining the cost and the enhanced perceived QoS as a function of the optimized level of the operational allocation.

9. The method of claim 1, wherein determining the optimized level of the provider's operational allocation involves optimizing perceived QoS via one or more of:
a constraint;
a stochastic constraint; and
a contribution to an objective function.

10. A non-transitory computer-readable storage medium storing instructions that when executed by a computer cause the computer to perform a method for optimizing perceived Quality of Service (QoS), the method comprising:
obtaining, by a computer, a Service Level Agreement (SLA) between a provider and a customer, wherein the SLA specifies a QoS metric;
optimizing the QoS metric and a perceived QoS for the customer, which further comprises:
modeling the customer's perceived QoS, based on an operational allocation of the provider;
modeling the QoS metric, based on the operational allocation of the provider; and
determining an optimized level of the provider's operational allocation that optimizes both the customer's modeled perceived QoS and the modeled QoS metric; and
setting the provider's operational allocation to the optimized level.

11. The non-transitory computer-readable storage medium of claim 10, wherein determining the optimized level of the provider's operational allocation involves constraining the provider's operational allocation to correspond to a modeled QoS metric within a range specified by the SLA.

12. The non-transitory computer-readable storage medium of claim 11, wherein the range for the QoS metric includes one or more of:
a minimum value of the provider's operational allocation;
a deadline for a task completion; and
a number of incomplete tasks.

13. The non-transitory computer-readable storage medium of claim 10, wherein modeling the customer's perceived QoS involves basing the perceived QoS on a worst value of the QoS metric over a recent time interval.

14. The non-transitory computer-readable storage medium of claim 10, wherein modeling the customer's perceived QoS involves basing the perceived QoS on one or more of:
an average value of the QoS metric over a recent time interval; and
a comparison of a recent value of the QoS metric to the average value.

15. The non-transitory computer-readable storage medium of claim 10, wherein determining the optimized level of the provider's operational allocation further comprises one or more of:
determining that providing the optimized level of operational allocation will increase a cost associated with the operational allocation by less than a predetermined threshold or proportion; and
determining the cost and the enhanced perceived QoS as a function of the optimized level of the operational allocation.

16. The non-transitory computer-readable storage medium of claim 10, wherein determining the optimized level of the provider's operational allocation involves optimizing perceived QoS via one or more of:
a constraint;
a stochastic constraint; and
a contribution to an objective function.

17. A computing system for optimizing perceived Quality of Service (QoS), the system comprising:
a set of processors; and
a non-transitory computer-readable medium coupled to the set of processors storing instructions thereon that, when executed by the processors, cause the processors to perform a method for optimizing perceived Quality of Service (QoS), the method comprising:
obtaining, by a computer, a Service Level Agreement (SLA) between a provider and a customer, wherein the SLA specifies a QoS metric and a corresponding range;
optimizing a perceived QoS for the customer based on the range for the QoS metric, which further comprises:
modeling the customer's perceived QoS, based on an operational allocation of the provider;
modeling the QoS metric, based on the operational allocation of the provider; and
determining an optimized level of the provider's operational allocation that enhances the customer's modeled perceived QoS, wherein the optimized level also corresponds to a modeled QoS metric within the range; and
setting the provider's operational allocation to the optimized level.

18. The computing system of claim 17, wherein modeling the customer's perceived QoS involves basing the perceived QoS on a worst value of the QoS metric over a recent time interval.

19. The computing system of claim 17, wherein modeling the customer's perceived QoS involves basing the perceived QoS on one or more of:
an average value of the QoS metric over a recent time interval; and
a comparison of a recent value of the QoS metric to the average value.

20. The computing system of claim 15, wherein determining the optimized level of the provider's operational allocation involves optimizing perceived QoS via one or more of:
a constraint;
a stochastic constraint; and
a contribution to an objective function.
